(19) United States
(12) Patent Application Publication
(10) Pub. No.: US 2008/0001917 A1
(43) Pub. Date: Jan. 3, 2008

(54) DEVICE FOR DISPLAYING VISUAL INFORMATION

(75) Inventors: Karin Stumm-Tippe, Eckental (DE); Klaus Ketterer, Oberwolfach (DE)

Correspondence Address: BROWDY AND NEIMARK, P.L.L.C.;624 NINTH STREET, NW, SUITE 300, WASHINGTON, DC, 20001-5303, US

(73) Assignee: Karin STUMM-TIPPE, Eckental (DE)

(21) Appl. No.: 11/745,316

(22) Filed: May 7, 2007

Related U.S. Application Data
(60) Provisional application No. 60/803,441, filed on May 30, 2006.

(30) Foreign Application Priority Data
May 5, 2006 (DE) 10 2006 020 979.6

(51) Int. Cl. G09G 5/00

(52) U.S. Cl. 345/156

(57) ABSTRACT

The device serves to present visual information (2). It comprises a display unit (1) incorporating a screen (3), a control unit (5), an actuator unit (4) that is in mechanical linkage (6) with the screen (3) for movement of the same, and incorporating a position sensor (9) that is connected to the control unit (5) for detection of a current position of the screen (3). The control unit (5) comprises calculation means (11) for calculation of the visual information (2) to be displayed from at least one current base image, under inclusion of current image change parameters and of the current position of the first screen (3).

The invention relates to a device for displaying visual information incorporating a screen and an actuator unit for moving the screen.

A device of this type is known, for example, from DE 103 13 023 B4. It is intended for the attention-drawing presentation of advertising messages in stores, at exhibitions and in public transportation. A control unit is used to dynamically synchronize a movement of the screen with visual information to be displayed. The screen movement is adjusted in dependence upon the visual information. A control loop with bi-directional data transmission between the actuator unit and control unit is provided for this purpose, and the actual value of the visual information is continually compared to the target value of the screen movement, and the actual value of the screen movement to the target movement of the visual information.

This double feedback in the control loop is complex. Additionally, a fixed interconnection default for the current screen movement and current visual information exists at each point in time. This places significant demands on the dynamics and positioning accuracy of the actuator unit. The device reacts sensitively to positioning errors of the actuator unit, so that, on the whole, the range of possible applications becomes limited.

The invention now has as its object to present a device of the type mentioned at the beginning that is tolerant with respect to positioning inaccuracies of the actuator unit and that has a high degree of flexibility.

To meet this object, a device according to the characteristics of claim 1 is presented. The inventive device for displaying visual information comprises a first display unit incorporating a first screen, first control unit, first actuator unit that is in mechanical linkage with the first screen for movement of the same, and incorporating a position sensor that is connected to the first control unit for detection of the current position of the first screen, wherein the first control unit comprises calculation means for calculation of the visual information to be displayed from at least one current base image under inclusion of current image change parameters and of the current position of the first screen.

In the case of the inventive device, in contrast to the prior-art device, no feedback of the current visual information to be displayed is provided to the actuator unit. In particular, the expenditure for a control loop with bi-directional data transfer is eliminated as well. Instead, only the position of the first screen is detected and incorporated into the current calculation of the visual information from the base image. Any position inaccuracy of the actuator limit plays virtually no role, since it is not a preset position of the first screen that is important, but rather its actual position, which is detected by means of the position sensor. This provides for very flexible applications of the inventive device. Moreover, the requirements with respect to dynamics and positioning accuracy of the actuator unit are much lower than in the case of the known device of the prior art. The inventive device is very fault tolerant with respect to the actuator.

Advantageous embodiments of the device according to the invention will become apparent from the characteristics of the dependent claims of claim 1.

Advantageous is a variant in which the first actuator unit is designed to provide for a movement of the first screen independently from the visual information. This reduces the implementation expenditure and increases the flexibility.

In accordance with another preferred variant, the first screen has a refresh rate and the calculation means are designed for calculation of the visual information to be displayed, to be performed in the cycle of the refresh rate and especially in real time. This makes it possible to bring to display even very rapid changes in the visual information to be displayed.

Additionally it is advantageous if the current image change parameters describe a segment to be displayed of the current base image wherein a current segment size parameter is provided for adjustment of a size of the segment to be displayed a current segment displacement parameter for adjustment of a displacement position of the segment to be displayed, and a current segment angle parameter for adjustment of an angle position of the segment to be displayed. The segment may, as a rule, also cover the entire base image. Based on these image change parameters, a segment to be displayed can be determined from the base image in a simple and very flexible manner.

Provision is advantageously also made for the calculation means to be designed for calculation of the current segment size parameter, current segment displacement parameter, and current segment angle parameter, in the cycle of the refresh rate by means of an interpolation between specifiable interpolation point values. This makes it possible to reduce the interpolation point density. The interpolation provides default values also at points in time that are located between the interpolation points.

In an additional favorable embodiment, the position sensor is designed for detection of a current displacement position of the first screen and current angle position of the first screen, and the control unit is designed for a determination derived therefrom of a current screen displacement parameter and a current screen angle parameter. These parameters are particularly suitable for inclusion of the current screen position in the calculation of the visual information to be displayed.

Also advantageous is a variant in which the calculation means are designed for calculation of the visual information to be displayed by means of matrix multiplications. These mathematical operations can very easily be programmed and carried out as software modules on a microprocessor. The matrix multiplications very easily permit the inclusion of both the image change parameters as well as the screen parameters. They are additionally suitable for a very rapid calculation of the visual information.

According to an additional advantageous embodiment, the first screen and the first control unit are combined to form a shared component. This results in a small size and the calculating capacities, which are already available, can be put to dual use if desired. The resulting short signal paths are advantageous as well. Particularly in the case of high-frequency signals, this will prevent undesirable emissions. Moreover, this integration makes an electrical sliding contact unnecessary, which would otherwise be required for the transmission of graphics signals from the first control unit to the first screen in order to bridge the mechanically movable point of the screen mounting. A slip ring that is suitable for transmission of the high-frequency graphics signals, however, is associated with considerable costs that can be avoided with the advantageous integration.

Additionally, it is advantageous if the current base image is a snapshot of a specifiable video sequence or image sequence. The base image may originate from a largely arbitrary source. This means that a very broad range of applications exists.

Additionally it is advantageous to design the calculation means such that the visual information to be displayed is determined from a superimposition of the information of at least two partial images, each of which is calculated from a current base image under inclusion of current image change parameters and of the current position of the first screen. This further increases the application potential.

In accordance with a further preferred variant, at least one second display unit is provided, incorporating a second screen, second control unit, second actuator unit that is in mechanical linkage with the second screen for movement of the same, and incorporating a position sensor that is connected to the second control unit for detection of a current position of the second screen. In this manner the presentations of the visual information can be designed even more impressively and diverse. In principle there is no limit to the number of display units. This means that three, four, or even more display units can be provided.

Additionally, there is a further advantageous design in which the first and second display unit have a common coordination unit. This provides for a synchronization, or at least for a time-coordinated start, of the partial presentations running on the respective display units. This prevents an undesirable time lag between the partial presentations in principle, however, any other type of synchronization can be implemented by means of the coordination unit as well. The coordination unit maybe designed as a separate unit or as a component of one of the display units. In particular, it may be formed by one of the control units.

In accordance with another favorable design, a simulation unit is provided that is removably connectable to the first control unit and to the first actuator unit for simulation of the display of the visual information. The simulation unit is particularly also removably connectable to all other potentially existing control and actuator units. The simulation unit permits in a very easy and comfortable manner the preparation and testing of a new visual presentation without the need for having the actual display units available for this purpose and/or having to put them into operation.

Moreover, the simulation unit is preferably designed for the generation of control sequences that are transmittable to the first control unit and to the first actuator unit. The control sequences can be stored particularly in the form of script files and transmitted to the display units. In this manner the information obtained during testing can also be used for the final visual presentation running on the display unit.

The characteristics and advantages described above for the inventive device also apply in the same or at least in a similar manner for the process or processes performed or running on the inventive device. These processes, too, shall be considered as attributable to the invention.

Additional characteristics, advantages and details of the invention will become apparent from the following description of exemplary embodiments with the aid of the drawing, in which:

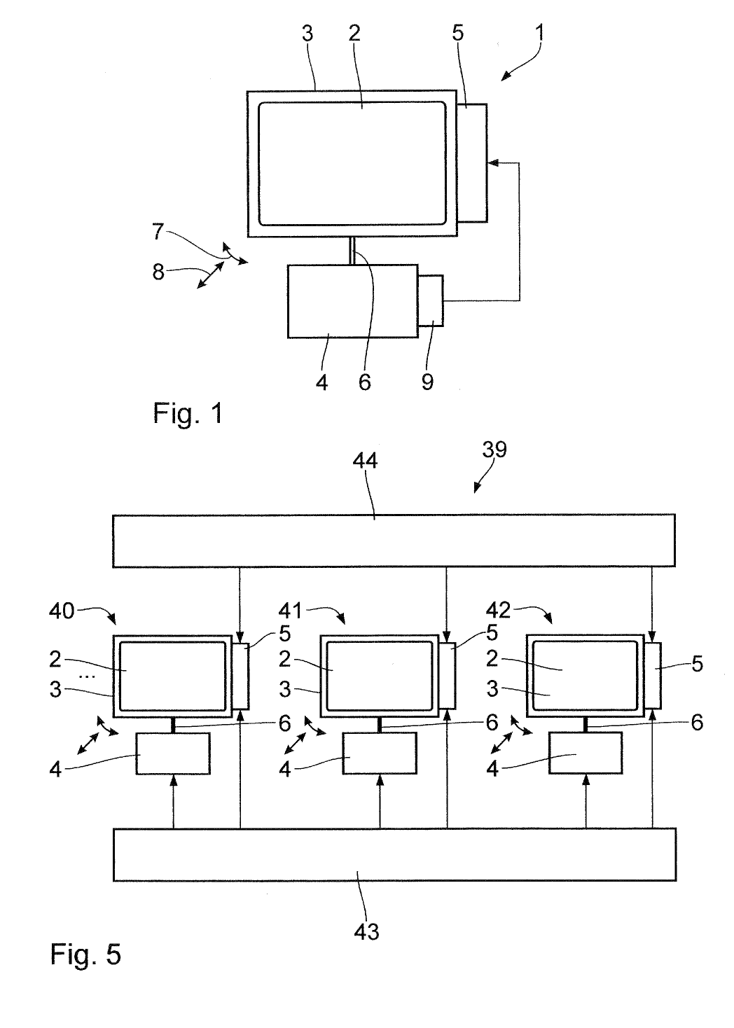

FIG. 1 shows a block diagram of a display unit for visual presentation, incorporating a screen that is movable via an actuator unit and incorporating a control unit,

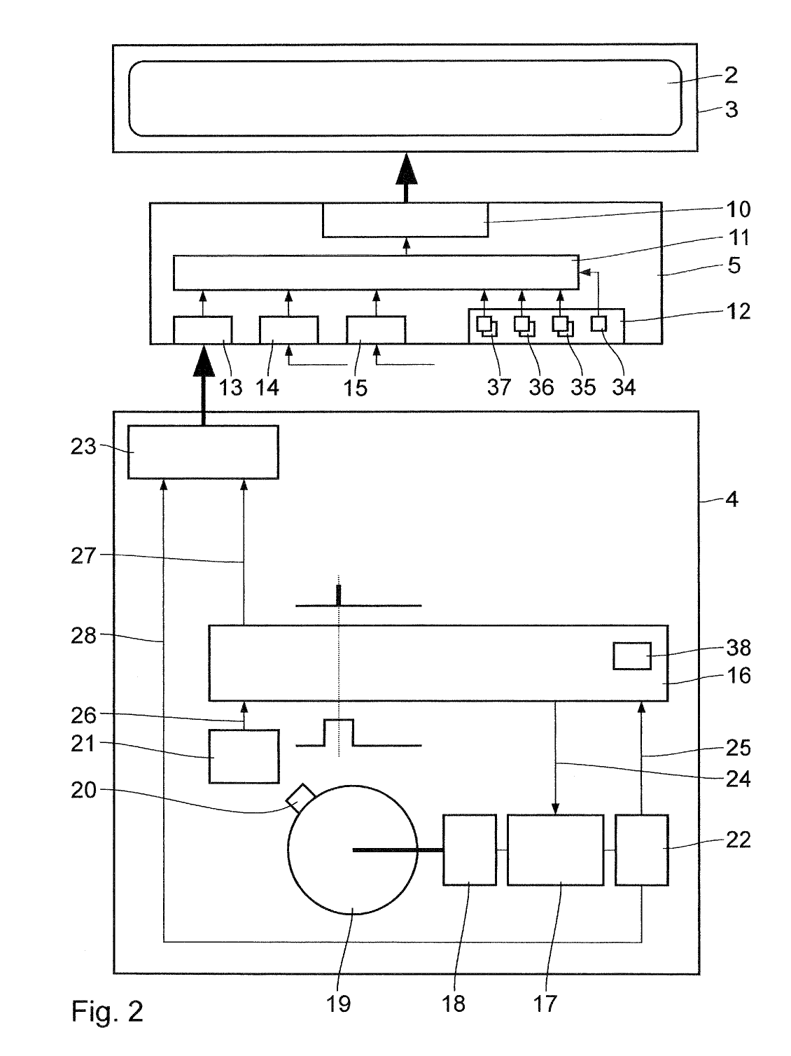

FIG. 2 shows a detailed block diagram of the display unit of FIG. 1,

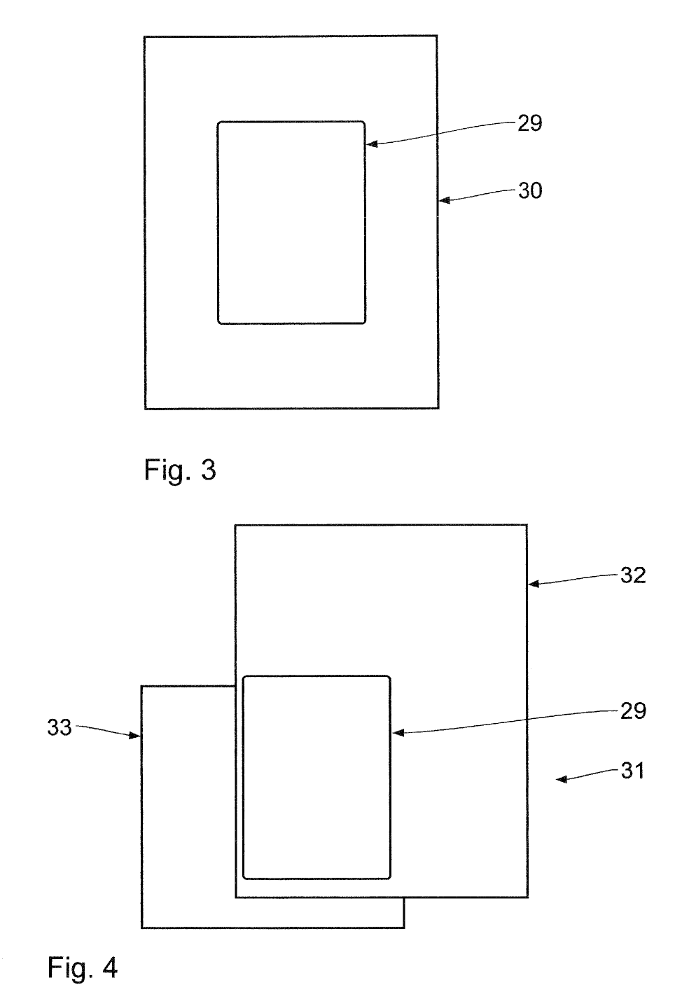

FIGS. 3 and 4 show an exemplary embodiments [sic] of base images, and visual information determined therefrom that is to be displayed on the screen of the display unit of FIGS. 1 and 2, and

FIG. 5 shows a block diagram of a device for visual presentation incorporating three display units according to FIGS. 1 and 2 and incorporating a connectable simulation unit and control unit.

Identical components in FIGS. 1 through 5 are shown with identical reference numerals.

FIG. 1 shows an exemplary embodiment of a device designed as a display unit 1 for display of a piece of visual information 2. The display unit 1 comprises a movable screen 3, an actuator unit 4, as well as a control unit 5, which together with the screen 3 form a modular unit. The screen 3 and the actuator unit 4 are coupled to each other by means of a mechanical linkage 6, so that the actuator unit 4 is able to move the screen 3. This movement may be implemented as a rotating and/or displacement movement. In FIG. 1 this is indicated by a rotational arrow 7 and translational arrow 8.

To detect the current position of the screen 3, a position sensor 9 is provided, which is associated in the exemplary embodiment with the actuator unit 4, but which is also connected to the control unit 5. The position sensor 9 thus detects the position of the screen 3 in the exemplary embodiment indirectly via a position detection on the actuator unit 4. In principle, however, the position detection may also take place in a different maimer instead. For example, the position sensor 9 may be disposed at a different location within the display unit 1, such as directly on the screen 3.

FIG. 2 shows a block diagram of the display unit 1 of FIG. 1. The screen 3, which is designed in the exemplary embodiment as a TFT or LCD screen, is electrically connected to the control unit 5, which is designed as a computer or computer component and comprises a standard graphics card 10, a calculation unit 11, as well as a memory unit 12. The graphics card 10 supplies the visual information 2 to be displayed on the screen 3. The latter can, in principle, also be designed as a plasma screen or as a large screen, for example in the form of an LED display wall. The high tolerance with respect to the positioning accuracy that is inherent to the display unit 1 consequently also permits the use and especially the movement of a very heavy screen. The memory unit 12 in the exemplary embodiment is designed as a hard drive. The calculation unit 11 comprises a microprocessor assembly or micro-controller assembly.

The control unit 5 additionally also has a measurement input 13, which is designed, for example, as a parallel interface (LPT) or USB interface. The measurement input 13 is connected to the position sensor 9. In addition, the control unit 5 has a network input 14 and video input 15. The network input 14 and video input 15 are optional.

The actuator unit 4 comprises a motor control unit 16, a motor 17, a linkage 18, a rotary table 19 designed as support for the screen 3, a reflected light barrier 21 that detects a reference point 20 on the rotary table, an incremental encoder 22 that is provided on the motor, as well as a counter 23.

The motor 17, the linkage 18, and the rotary table 19 are mechanically linked to each other in such a way that the motor 17 can effect a rotary movement of the rotary table 19. Depending on the design of the mechanical linkage between the motor 17 and rotary table 19, a displacement of the rotary table 19 can additionally be made possible as well.

The motor control unit 16 is connected to the motor 17 by means of a control line 24, to the incremental encoder 22, as well as to the reflected light barrier 21 by means of signal lines 25 and 26, and to the counter 23 by means of a reset line 27. In the exemplary embodiment according to FIG. 2, the position sensor 9 is designed in two parts. It comprises the incremental encoder 22 and the counter 23, which are connected to each other by means of a signal line 28.

The mode of action and specific advantages of the display unit 1 will be described below, with reference made also to FIGS. 3 and 4.

In the calculation unit 11 of the control unit 5, the visual information 2 to be displayed is re-calculated within the duration of each image refresh period and routed to the graphics card 10 that brings about the actual display on the screen 3.

Independently from this calculation performed by the control unit 5 and display of the visual information 2, the motor control unit 16 of the actuator unit 4 determines whether a change in the actuator position and therefore in the screen position must be performed and initiates this if required. In the motor control unit 16 the control signals for the motor 17 are determined under inclusion of the measured values supplied by the incremental encoder 22 and by the reflected light barrier 21. The incremental encoder 22 detects a position of the motor 17 and reports a change in the actuation position in the form of counting pulses, both to the motor control unit 16 and to the counter 23. The reflected light barrier 21 detects the reference point 20 on the rotary table 19 and makes this information available to the motor control unit 16 as well.

In the control unit 5 and in the actuator unit 4, a control program has been stored in each case with default information relating to the respective task, i.e., image calculation and display, or screen movement. Both control programs are independent from each other.

These control programs comprise interpolation points on a time scale. At least one actuator displacement parameter and at least one actuator angle parameter are stored in the actuator unit 4 for each interpolation point, which indicate a displacement position or angle position to be set by the actuator unit 4 at the point of time of this interpolation point. Between the individual interpolation points, which, in principle, may be provided in arbitrary time intervals, the motor control unit 16 determines the default values for the displacement position and angle position in the exemplary embodiment by means of a linear interpolation. Other methods for determining the default values between the interpolation points for controlling the motor 17 are possible as well. This also holds true especially also for non-linear interpolation methods.

Interpolation points with image change parameters on a time scale are also stored in the control unit 5. The image change parameters that are stored per interpolation point comprise at least one segment size parameter, at least one segment displacement parameter, and at least on segment angle parameter. These parameters describe the size, displacement position and angle position of a segment 29 of a base image shown by way of example in FIG. 3. The segment 29 substantially corresponds to the visual information 2 to be displayed on the screen 3. It may fill the display field of the screen 3 either completely or also only partially.

The base image 30 may change over time or remain constant. It is also possible to provide an overlay of two partial images 32 and 33 as the base image 31. This is depicted in FIG. 4. The overlay is of advantage especially when the segment 29 is moved past the edge of the first partial image 32 during the course of the presentation, as this would be the case, for example, with a rotation of the segment 29 shown in FIG. 4. In order to prevent the segment 29 from then having an undefined content in this region, the second partial image 33 is stored at this location behind the first partial image 32.

The above mentioned image change parameters, i.e., the segment size parameter, segment displacement parameter and segment angle parameter, are stored per interpolation point, and the interpolation points, in turn, may be provided in arbitrary time intervals.

An interpolation is performed between the interpolation points, like in the actuator unit 4.

In an embodiment that is not shown, the visual information 2 to be displayed is composed of more than one segment 29. The individual segments may be located next to each other or at least partially over one another. This is done using the overlay technique, which is known per se.

In addition to the image change parameters, information regarding which base image 30 and/or 31 should be used at a given point in time is stored in the memory unit 12 as well. In the exemplary embodiment, this is done in the form of a script file 34. The respective utilized base images 30 and 31 in the exemplary embodiment exist as media files. Their content and also the origin of these media files is largely arbitrary.

They may be stored as text ticker files 35, as image files 36, and as video files 37 in the memory unit 12. However, they may also be fed in live via the network input 14 or video input 15 from a data network, for example from the Internet or from a digital video camera that is recording live. The information, which of the above mentioned available sources should be used at a given point in time is stored in the script file 34. It is certainly possible in this context to use multiple sources simultaneously to create the visual information 2 to be depicted.

The control unit 5 receives indirect information via the measurement input 13 regarding the displacement position and angle position of the screen 3. With the aid of data made available by the counter 23 with respect to the displacement position and angle position of the motor 17, current screen displacement parameters and current screen angle parameters are determined. These also enter into the determination of the visual information 2.

In the calculation unit 11, matrix multiplications are performed, in such a way that one matrix is prepared in each case for the three image change parameters, i.e., the current segment size parameter, the current segment displacement parameter and the current segment angle parameter, as well as for the current screen displacement parameter and current screen angle parameter, the matrix describing the respective displacement, rotation or size adjustment according to the rules of general algebra for coordinate transformation. After multiplication of these five matrices with the selected current base image 30 and/or 31, the visual information 2 to be displayed is obtained for the current duration of the image refresh period. This means that per visual information 2 to be displayed, five matrix multiplications are performed in each case. This determination of the visual information 2 per matrix operation takes place in real time, i.e., in the cycle of the image refresh rate of the screen 3.

Advantageously neither the actuator displacement parameters nor the actuator angle parameters, i.e., the target values stored in the actuator unit for the displacement position and angle position of the motor 17, enter into the determination of the visual information 2. Instead, the (indirectly) measured actual displacement position and rotational position of the screen 3 are used. This eliminates problems stemming from the dynamics being too low or from a positioning inaccuracy of the actuator unit 4. The control unit 5 is able to adjust the visual information 2 that is brought to display to the given current screen position.

Conversely, control of the motor 17 takes place in the actuator unit 4 independently from the visual information 2 that is to be displayed at that time. Of importance are only the default values at the interpolation points, which are stored in the actuator unit 4. The actuator displacement parameters and the actuator rotation parameters of the respective interpolation points are also stored in a script file 38.

On the whole, the display unit 1 is very robust and insensitive to interference. Additionally, the visual information 2 that is calculated for each individual display image in the cycle of the image refresh rate allows for a very flexible adaptation to a large variety of applications.

FIG. 5 depicts, in a block diagram, an exemplary embodiment of a device 39 for visual presentation incorporating a total of three display units 40, 41 and 42. The display units 40 through 42 correspond in their design and mode of action to the display unit 1 according to FIGS. 1 through 4. A simulation unit 43 and a coordination unit 44 are provided in addition. The simulation unit 43 is removably connected to the actuator units 4 and control units 5 of the display units 40 through 42. The coordination unit 44 is connected to the control units 5 of the display units 40 to 42.

The simulation unit 43 in the exemplary embodiment is designed as a stand-alone computer, which is designed for preparation of a visual presentation on the device 39. For this purpose, the movements of the screens 3 of the display units 40 through 42 and the respective visual information 2 to be displayed are simulated in their entirety in the simulation unit 43 to try out the sequence of the interpolation points with their parameters to be stored in the actuator units 4 and control units 5, and to make a final determination as to when a satisfactory visual presentation has been achieved. These interpolation points and the associated parameter values are then stored in the script files 34 and 38. The script files 34 and 38 that have been prepared in this manner are transmitted to the control units 5 and actuator units 4 of the display units 40 to 42 to be stored. The connection to the display units 40 through 42 can then be disconnected. The simulation unit 43 is not required for carrying out the visual presentation. It serves primarily for preparing the visual presentation.

The optional coordination unit 44 is provided especially if the visual information 2 shown on the display units 40 to 42 is to be synchronized. If this is not the case, the coordination unit 44 may be eliminated. Otherwise, the main function of the coordination unit 44 consists of the simultaneous triggering of the partial presentations running on the two display units 40 to 42. After that, the respective partial presentations will run on the display units 40 through 42 independently from each other.

In an alternative embodiment that is not shown, the coordination function may also be assumed by one of the control units 5.

What is claimed is:

1. A device for displaying visual information (2) comprising
a) a first display unit (1; 40, 41, 42) incorporating a first screen (3) a first control unit (5), a first actuator unit (4) that is in mechanical linkage (6; 19) with the first screen (3) for movement of the same, and incorporating a position sensor (9) that is connected to the first control unit (5) for detection of a current position of the first screen (3), wherein
b) the first control unit (5) comprises calculation means (11) for calculation of the visual information (2) to be displayed from at least one current base image (30, 31), under inclusion of current image change parameters and of the current position of the first screen (3).

2. A device according to claim 1, characterized in that the first actuator unit (4) is designed to provide for a movement of the first screen (3) independently from the visual information.

3. A device according to claim 1, characterized in that the first screen (3) has a refresh rate and the calculation means (11) are designed for calculation of the visual information (2) to be displayed, to be performed in the cycle or the refresh rate and especially in real time.

4. A device according to claim 1, characterized in that the current image change parameters describe a segment (29) to be displayed of the current base image (30; 31), wherein a current segment size parameter is provided for adjustment of a size of the segment (29) to be displayed, a current segment displacement parameter for adjustment of a displacement position of the segment (29) to be displayed, and a current segment angle parameter for adjustment of an angle position of the segment (29) to be displayed.

5. A device according to claims 3 and 4, characterized in that the calculation means (11) are designed for calculation in the cycle of the refresh rate of the current segment size parameter, current segment displacement parameter and current segment angle parameter by means of an interpolation between specifiable interpolation point values.

6. A device according to claim 1, characterized in that the position sensor (9) is designed for detection of a current displacement position of the first screen (3) and current angle position of the first screen (3), and the control unit (5) is designed for a determination derived therefrom of a current screen displacement parameter and current screen angle parameter.

7. A device according to claim 1, characterized in that the calculation means (11) are designed for calculation of the visual information (2) to be displayed by means of matrix multiplications.

8. A device according to claim 1, characterized in that the first screen (3) and the first control unit (5) are combined to form a shared component.

9. A device according to claim 1, characterized in that the current base image (30; 31) is a snapshot of a specifiable video sequence or image sequence.

10. A device according to claim 1, characterized in that the calculation means (11) are designed for determination of the visual information (2) to be displayed from a superimposition of the information of at least two partial images, each of which is calculated from a current base image (30; 31) under inclusion of current image change parameters and of the current position of the first screen (3).

11. A device according to claim 1, characterized in that at least one second display unit (41, 42) is provided, incorporating a second screen (3), a second control unit (5), a second actuator unit (4) that is in mechanical linkage with the second screen (3) for movement of the same, and incorporating a position sensor that is connected to the second control unit (5) for detection of a current position of the second screen (3).

12. A device according to claim 11, characterized in that the first and second display unit (40, 41, 42) have a common coordination unit (44).

13. A device according to claim 1, characterized in that a simulation unit (43) is provided that is removably connectable to the first control unit (5) and to the first actuator unit (4) for simulation of the display of the visual information (2).

14. A device according to claim 13, characterized in that the simulation unit (43) is designed for the generation of control sequences that are transmittable to the first control unit (5) and first actuator unit (4).
